(19) United States
(12) Patent Application Publication
(10) Pub. No.: US 2009/0327499 A1
(43) Pub. Date: Dec. 31, 2009

(54) METHOD AND SYSTEM FOR MEDIATED CODEC NEGOTIATION

(75) Inventors: David Peter Strickland, Carp (CA); Ronald Brett Buckingham, Kanata (CA); Anna Cheung, Kanata (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: NATURAL CONVERGENCE INC., Ottawa, ON (CA)

(21) Appl. No.: 12/305,763

(22) PCT Filed: Jan. 8, 2008
(86) PCT No.: PCT/CA2008/000022

§ 371 Date: Dec. 19, 2008

Related U.S. Application Data
(60) Provisional application No. 60/883,885, filed on Jan. 8, 2007.

(51) Int. Cl. G06F 15/16; H04L 12/66

(52) U.S. Cl. 709/228; 370/252

(57) ABSTRACT

The solutions offered herein include introducing a mediator in the codec: negotiation process. Rather than having the endpoints negotiate codecs directly, the mediator receives signaling from the endpoints relating to the establishment of a communication session which requires codec negotiation, and influences the selection of a codec based on codec policy criteria which depends on known topology information.

### CROSS REFERENCE TO RELATED APPLICATIONS

This application claims the benefit of priority of U.S. Provisional Patent Application No. 60/883,885 filed Jan. 8, 2007, which is incorporated herein by reference.

### FIELD OF THE INVENTION

The present invention relates generally to codec (coder-decoder) negotiation. More particularly, the present invention relates to a system for controlling codec negotiation for VoIP systems.

### BACKGROUND OF THE INVENTION

Traditional telephony solutions which were previously delivered by circuit switched telephony applications are increasingly being provided by Voice over Internet Protocol (VoIP) applications. Examples of circuit switched telephony applications include the Public Switched Telephone network (PSTN) for carriers and Private Branch Exchanges (PBXs), Key Systems and Centrex applications for enterprises.

The enterprise solutions typically provide 2 major advantages. First they allow an enterprise to provide telephone access for its members without requiring a separate outgoing line to the PSTN for each member. In other words, they allow a several members to share Network Access Resources (for example, external telephone lines). Second, they typically provide a larger set of features to its members.

As stated, VoIP is now being used to provide telephony. This is being implemented for several reasons. For example, consumers have found that VoIP calls are not subject to long distance telephone charges. Enterprises previously required separate voice and data networks, which can now be integrated. Furthermore, non traditional telephone operators can now provide telephony services to their subscribers using data networks (e.g., cable operators).

Accordingly, protocols for VoIP call set-up have been developed which typically require signaling between the endpoints of a call, and the endpoints are typically involved with each call set-up. Examples of such protocols are H.323, Session Initiation Protocol (SIP) and MGCP. As will be appreciated by a person skilled in the art, voice is typically carried using Real Time Protocol (RTP) over UDP/IP.

Many digital telephony systems, for example Voice over IP communication, require the encoding of voice samples for transmission over a data network. The voice coding (vocoding) and decoding of the voice is typically performed by a function referred to as a codec (coder-decoder). The vocoded packets are what is typically carried by RTP.

Many algorithms exist to encode and decode voice samples, each with their own benefits. For example, some of these algorithms make use of compression and allow the voice traffic to be carried using less bandwidth on the data network. Typically, there is a trade-off between voice quality and bandwidth requirements, such that increasing the amount of compression reduces the amount of bandwidth required but reduces the amount of speech information which is actually transmitted (which can affect the perceived voice quality).

One problem that has arisen from the fact that there are many Codecs which are used is that Codecs do not typically interwork. That is a voice stream encoded using a given codec cannot typically be decoded using a different codec. Furthermore, VoIP capable devices are often capable of using more than one Codec. However, most such devices are not equipped with every Codec. Accordingly, it is important to ensure that a compatible algorithm is used by the endpoints of the voice stream.

A common solution to this problem is to have the end-points of a call negotiate which Codec to use. This involves signaling between the end-points as part of call-set-up according to the above mentioned protocols, wherein the end-points negotiate the use of a Codec, assuming there is a common codec supported by both endpoints. Such a solution is described in RFC 3264: An Offer/Answer Model with the Session Description Protocol (SDP), Rosenberg & Schulzrinne, The Internet Society, 2002 located, e.g., at http://www.ieff.org/rfc/rfc3264.txt?number=3264 (the contents of which are hereby incorporated by reference).

However, such an approach assumes the endpoint is capable of formulating and receiving session description protocol (SDP) messages. Thus an alternative needs to be found for supporting phone device control protocols for PBXs or Feature Servers (also known as Call Processing Servers), and the features and devices supported by these protocols, which often offer a broader and/or more customized set of features than are available via typical SDP supported protocols (which typically are limited to SIP, MGCP or H.323). In this specification, the term Feature Server (FS) and Call Server (CS) include suitably configured PBXs, key systems, call processing servers and centrex applications.

In addition, as stated, one of the factors to consider in choosing codec depends on a trade-off between voice quality and bandwidth requirements. However as the endpoints typically are not aware of topology considerations, they typically do not have sufficient information to make such a trade-off. Accordingly, while such an end-point negotiation solution is often able to negotiate a compatible Codec between the endpoints—it is often not the best one.

Another solution is to have an intermediary, for example a gateway or conferencing system, translate and transcode the RTP packets, so that the end points can still communicate, even if there is no common codec. The challenges with using an intermediary include (but are not limited to): the need to decode and re-encode voice packets increases delay in the end to end transmission of the voice (and as a result can decrease the voice quality as perceived by listeners); such an intermediary requires additional equipment and software that offers additional points of failures and increased cost into a VoIP network; potential loss of voice information in the decoding and encoding process that will result from a translation.

It is, therefore, desirable to provide a more flexible codec negotiation system.

### SUMMARY OF THE INVENTION

It is an object of the present invention to obviate or mitigate at least one disadvantage of previous codec negotiation systems.

The solutions offered herein include introducing a mediator in the codec negotiation process. Rather than having the endpoints negotiate codecs directly, the mediator receives signaling from the endpoints, relating to the establishment of a communication session which requires codec negotiation, and influences the selection of a codec based on codec policy criteria which depends on known topology information.

In brief, the codecs, and their preferences, which would normally be advertised by endpoint devices, are altered by allowed codecs and preferences based on policy decisions which depend on the topology. These policy decisions can be based on a priori knowledge of the topology. In addition, in some embodiments, these policy decisions also take into account the current status of the topology and is bandwidth constraints.

The mediator is aware of network topology and can modify the codec negotiation to accommodate site-preferences (a site is a group of devices that share 1 or more access connections). Preferably the mediator can identify if an endpoint is at a bandwidth-constrained site or in the core of the network and can give higher importance to the codec preferences of a bandwidth-constrained site than to the preference of a core endpoint to influence the negotiation.

In one exemplary embodiment, the mediator receives the Session Description Protocol signaling messages (SDPs) sent by the endpoints (or generates an SDP on behalf of an endpoint which does not generate one itself) and has the ability to modify an SDP to optimize the codec negotiation before forwarding it to the other endpoint. By modifying the SDP, the mediator has the ability to influence (and in many cases dictate) the codec selected for a given stream. Advantageously, embodiments of the invention do this in such a manner that existing devices, configured for SDP based endpoint negotiation, can be used without software or hardware changes. As far as these devices are concerned, they operate in the same manner, sending and responding to messages with codec preferences as if they were negotiating the codec with the other endpoint. The mediator intercepts these messages, and can change the codec preferences based on topology information known to the mediator. One implementation of the mediator has that function performed by a hosted IP-telephony application server (for example an IP PBX, Key system, Call Server, or Feature server) which we will refer to as a Feature server.

In a first aspect, the present invention provides a method of negotiating codecs between endpoints of a session comprising, at a mediator: (1) receiving from a first endpoint, a request for communication with a second endpoint, at least one of said endpoints being a mediator associated endpoint which communicates via an access connection; (2) evaluating said request and retrieving codec policy criteria dependent on said access connection; and (3) determining, based at least in part on said codec policy criteria, an ordered list of codecs to include in codec negotiation messages for said mediator associated endpoint.

In further aspect, the present invention provides, for a system which negotiates codecs via signaling messages between endpoints, wherein each endpoint advertises the preferred order of allowed codecs within said signaling messages, a mediator for a device associated with said mediator, said mediator comprising a processor and computer readable medium tangibly embodying software instructions, which when executed by said processor, causes said mediator to: (a) intercept signaling messages relating to (i.e., to or from) said device; (b). re-order said preferred order of allowed codecs according to policy; and (c). transmit signaling messages which contain said re-ordered preferred order of allowed codecs.

According to one such embodiment said policy comprises a hierarchy of policies, each level of which specifies a trade-off between bandwidth and quality. As an example, said hierarchy depends on administrative domains at one level, and topology at another level. One example is for an multi-tenant VoIP system, wherein each tenant can have its own policy, and wherein each tenant represents an administrative domain for an organization which includes one or more sites. Typically each site includes one or more devices which share at least one access connection. As such an access connection is more likely than other parts of the hierarchy to be subject to bandwidth constraints, a mediator according to an embodiment of the invention implements a policy which gives precedence to site preferred codec combinations. However, said policy can additionally provide tenant preferred codec combinations, which are given precedence if a call does not involve a site.

Another aspect of the invention provides a computer program product tangibly embodied in a computer readable medium, which when executed by a processor of a feature server, causes said feature server to act as a mediator.

Another aspect of the invention provides a feature server comprising: (a). means for receiving from a first endpoint, a request for communication with a second endpoint, at least one of said endpoints being associated with said feature server; (b). means for evaluating said request and retrieving codec policy criteria dependent on topology information; (c). means for determining, based at least in part on said codec policy criteria, an ordered list of codecs to include in codec negotiation messages for said endpoints; and (d). means for sending said codec negotiation messages to said endpoints.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a schematic diagram illustrating an exemplary network topology.

FIG. 2 is a block diagram illustrating software blocks for a call server, according to an embodiment of an invention.

FIG. 3 is a block diagram illustrating SDP processing for three different scenarios according to an embodiment of the invention.

FIG. 4 is a flowchart illustrating the steps carried out by an Offerer endpoint abstraction device, according to an embodiment of the invention.

FIG. 5 is a flowchart illustrating the steps carried out by an Answerer endpoint abstraction device, according to an embodiment of the invention.

### DETAILED DESCRIPTION

Generally, the present invention provides a method and system for topology-aware codec negotiation, for example for VoIP applications. We will now discuss exemplary embodiments of such topology-aware codec negotiation with respect to an example in the context of a multi-tenant voice-over-ip system. However, we note the same principles can be extended to other voice-over-ip applications and to other non-voice applications requiring the negotiation of compatible codecs between endpoints.

It should be noted that in addition to using the same codec, devices should also use the same packetization interval (i.e. the size of the voice sample) to be compatible. Unless otherwise specified, the term codec in this specification will refer to the actual codec algorithm as well as other attributes which should be matched between the endpoints (such as packetization interval).

In the following description, for purposes of explanation, numerous details are set forth in order to provide a thorough understanding of the present invention. However, it will be apparent to one skilled in the art that these specific details are not required in order to practice the present invention. In other instances, well-known electrical structures and circuits are shown in block diagram form in order not to obscure the present invention. For example, specific details are not provided as to whether the embodiments of the invention described herein are implemented as a software routine, hardware circuit, firmware, or a combination thereof.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium, including magnetic, optical, or electrical storage medium including a diskette, compact disk read only memory (CD-ROM), memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine readable medium may interface with circuitry to perform the described tasks.

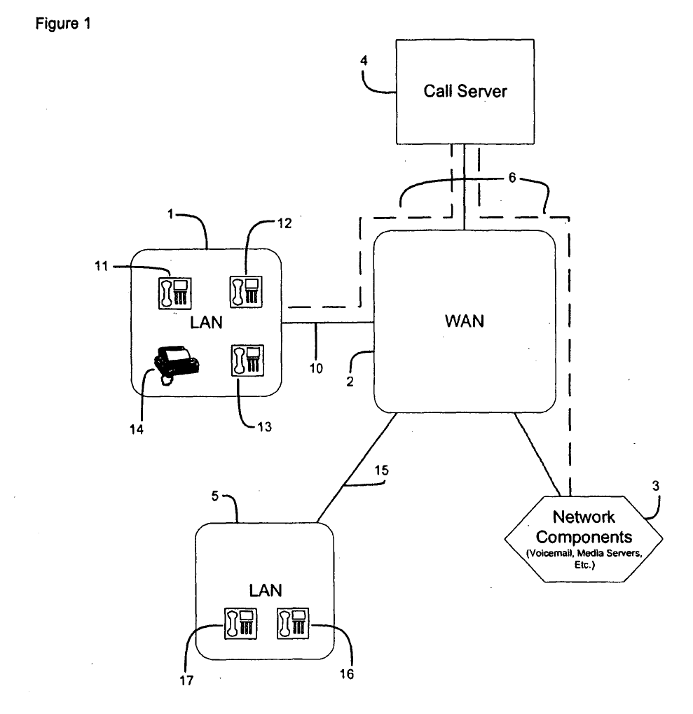

One example of a voice over IP (VoIP) application is a hosted application server allowing a service provider to deliver a voice-over-IP service to a number of independent businesses (also known as tenants). An example of such a scenario is illustrated in FIG. 1, according to an embodiment of the invention. As described above, one of the advantages of PBXs and Key Systems is the ability to share Network Access Resources. This is also desirable for computers and other IP devices on a Local Area Network (LAN) which require communication with the Internet. Thus, for example, several devices (including computers and VoIP telephones) connected on a LAN can share one or more access connections (e.g., DSL, cable or T1) for internet access. Each business can have a number of physical locations (sites) connected by a data network. FIG. 1 illustrates a first site 1 and second site 5. In this example, we will assume these belong to different tenants each supported by a common Call Server 4. However, it should be appreciated that each tenant may have more than 1 site, which can be associated with Call Server 4 or another Call Server (not shown). A site is a group of devices that share 1 or more access connections. In this figure, each site comprises a LAN with one or more VoIP endpoints located at each site. These endpoints include, for example, VoIP telephones, analog terminal adaptors converting analog devices into VoIP endpoints, or personal computers running a VoIP application. VoIP telephones can be independent devices capable of signaling and traditional end-point negotiation using such protocols as H.323, SIP, and MGCP. The VoIP telephones can alternatively be stimulus telephones which are controlled by a Feature Server, for example Call Server 4. The devices at a tenant site are also referred to as “tenant-scope” or “site-scope” devices.

The access between the individual sites and the data network has a limited amount of bandwidth, for example via access link (also called broadband connection) 10 for site 1, and access link 15 for site 5, to a service provider core network, for example via WAN 2. WAN 2 typically comprises the service provider's IP server. Note for ease of illustration, other devices associated with a site, for example Network Address Translation (NAT) devices, or with the service provider, for example Session Border Controllers (SBC) and routers, which will often be involved, but are not necessary for understanding the workings of the embodiments of the invention, have not been shown.

Typically, there is ample bandwidth within the LAN 1 and WAN 2 (which is generally run by the service provider). However the access connection is typically bandwidth constrained. One aspect of the invention provides a mechanism for taking this topology information into account during codec negotiation. In FIG. 1, the topology comprises the LAN, the access connection, and the WAN. The topology information includes information (including bandwidth constraints) for the different network sections which the RTP stream transverses. This is typically not possible during traditional codec negotiation which is executed by the endpoints, as the endpoints are typically unaware of any bandwidth constraints in such a connection.

The service provider's network typically also includes shared devices 3 used to provide service to the tenants such as voicemail servers, media servers used to deliver functions like an automated attendant, or gateways or softswitches used to interwork with other networks. These shared devices are also referred to a “network components”. While the service provider is not necessarily a telephone company or carrier, such components are also referred to as “telco-scope” components.

To effectively provide negotiated codecs which take into account topology such as the above described bandwidth constraints, a number of factors are taken into account by embodiments of the invention:
1. What codecs are supported by each device?
2. What codecs are allowed and preferred at each site?
3. What codecs are allowed and preferred by a tenant?
4. What codecs are allowed and preferred on the system?
5. Given a number of possible codecs and derived preferences for each endpoint, how is the codec to be used chosen?

For the purposes of specifying factors 2, 3 and 4 for a system with multiple codecs, we utilize a concept of codec combinations when negotiating codecs. A combination can have one or more codecs, wherein each codec is considered to be allowed, and the order of the codecs provides the preference. Devices which employ certain protocols such as MGCP and SIP will provide their own codec combinations in the form of an SDP.

A list of Codecs can be specified as “supported” at the system level. The system will typically not allow a call to connect using a codec which is not in the “supported” codec list. From the supported codecs, codec combinations are defined. Each combination consists of one or more codecs where the order of the codec in the list specifies the preference, with the first codec in the list being the most preferred. One of the combinations is specified as the system-preferred codec combination. The system can optionally support a variety of the packetization intervals, according to embodiments of the invention, although other embodiments can require a single interval for all codec. As we stated earlier, the term codec is used to refer both to the codec algorithm and the packetization interval. Accordingly, an embodiment of the invention can provide codec combinations with separate entries in the ordered list for differing pairings of algorithm and packetization interval. For example, a codec combination can have more then one codec entry using the same algorithm, and the order of preference depends on the packetization interval. However, we note that these can be specified and treated separately, with packetization intervals specified for each codec combination

For example, with only G711 and G729 as system codecs, the possible codec combinations are G711 only, G729 only, G711/G729 (both G711 and G729 are available, but G711 is used in preference) and G729/G711. In this example, G711 requires more bandwidth than G729, but typically provides better voice quality. So the order represents a policy decision as to the preference given between bandwidth conservation and quality.

At the tenant level, codec combinations derived from the system codec set are defined. Each tenant should have a codec combination. This combination should be used as the default when creating a tenant site. This tenant combination can also be used in negotiating on behalf of network components used by the tenant, including (but not limited to) gateways, softswitches, RTP Proxies, voicemail, media servers and bridge servers.

Similarly, at the site level, codec combinations derived from the tenant codecs are defined. Each site should have a codec combination which defines the order of preference of the codecs which the site will support. The call server will replace device specified codec combinations with a codec combination which is restricted to codecs supported by both the device and site, and re-ordered according to the preference indicated in the site codec combination. The site codec combination will also determine the preferences for ordering device supported codecs in the codec combination the call server generates for devices (for example, stimulus devices) which do not provide their own codec combination in the form of an SDP (session description protocol).

Both the Tenant and Site codec combinations are defined based on policy considerations which depend on the system topology. In brief, the codecs, and their preferences, which would normally be advertised by endpoint devices, are modified by codec combinations based on policy decisions which depend on the topology. These policy decisions are based on a priori knowledge of the topology. In addition, in some embodiments, these policy decisions also take into account the current status of the access connection. For example, The Call Server has a priori knowledge of the bandwidth available to each site, based on knowledge of the type of access connection. The call server also has a priori knowledge of the number and type of devices which share such a connection. This a priori knowledge can be determined by provisioning, auto-discovery techniques, or both. Therefore according to an embodiment of the invention, the policy provisions a codec combination for each site based on this topology information.

The Call Server also has knowledge of all RTP streams and the codecs used on the broadband connections to the site. Accordingly embodiments of the invention can make policy decisions to change the site codec combination based on the current state of the access connection.

To address factor 5: when a call is made between any two endpoints there is a set of common codecs that are available at all sites, tenants and endpoints involved. Given this, an embodiment of the invention applies the following rules:
1. If there are no common codecs, then the call should be denied.
2. If there is one common codec, use it.
3. If there are more than one common codec, then look at the preferred codec for all sites involved.
   a) If the preferred codecs are the same, then use it.
   b) If the preferred codecs are different, then use the lower bandwidth codec.
4. If there are more than one common codecs, and there are no sites involved, then use the preference from the Tenant.

Table 1 sets out 6 examples of how these rules are applied to select a codec. In this example, Stimulus is used to identify a device which does not specify codec preference in an SDP and SIP is used to identify a device which does. Furthermore, each device is described before the @ symbol, and the codec combination for the associated site (or Tenant) is provided after the @ symbol.

TABLE 1

| # | Device One | Device Two | Codec | Rule |
|---|---|---|---|---|
| 1 | Stimulus @ G711/G729 site | Stimulus @ G729/G711 site | G729 | 3b |
| 2 | Stimulus @ G711 only site | Stimulus @ G729/G711 site | G711 | 2 |
| 3 | Stimulus @ G711 only site | Stimulus @ G729 only site | Denied | 1 |
| 4 | SIP (G711) @ G729/G711 site (fax | Gateway for G711/G729 Tenant | G711 | 2 |
| | FXS) | | | |
| 5 | SIP (G711) @ G729 site | Anything | Denied | 1 |
| 6 | Gateway for G729/G711 Tenant | Voicemail (G711/G729)for | G729 | 4 |
| | | G729/G711 Tenant | | |

In example 1, rule 3b results in G.729 being selected, as the two sites have different preferred codecs (as can be seen by the different order of the codecs, despite the fact that both are in common), and G.729 uses less bandwidth than G.711. In example 2, rule 2 governs as there is only 1 common codec. In Example 3 there is no common codec, so the call is not possible (denied) as per rule 1. In example 4, the device only supports a single codec, so there is only a single common codec (rule 2 governs). In example 5, there is no common codec. Note that device 2 is irrelevant to the outcome as device one is not compatible with its site, and therefore can not be used at that site. In example 6, the preferred codec according to the tenant preference is used (as it takes precedence over the device preference).

During a phone-to-phone call within the LAN 1, it is possible to simply use the best codec in common between the phones, as there is no need to conserve bandwidth of the external broadband connection 10. However, the Call Server 4 can instruct the phones to use codecs based on site preferences. For example, policy decision can be made that internal and external calls should have the same quality so the users won't be able to tell the difference between an intra LAN call and a call that spans a broadband connection.

When a call traverses over 2 or more different broadband connections, the mediator decides which policy should take precedent. Generally this will be the one with the lower bandwidth requirement for two reasons. First, the lower bandwidth requirement is typically set as such for a reason—for example, a site with a highly used broadband connection will typically have a policy of choosing to use a Codec that uses higher compression in order to minimize the bandwidth usage of any given call even though the voice quality will be poorer, in order to maximize the number of concurrent calls which can occur. It will therefore place higher compression codecs before low compression codecs within the ordered list, in order to indicate their preference for the site. Second, while each leg of a call can use a different quality codec by means of conversion at a gateway, conversion between a high quality codec transmission and a lower quality codec transmission will typically result in quality which is, at best, equal to the lower quality codec.

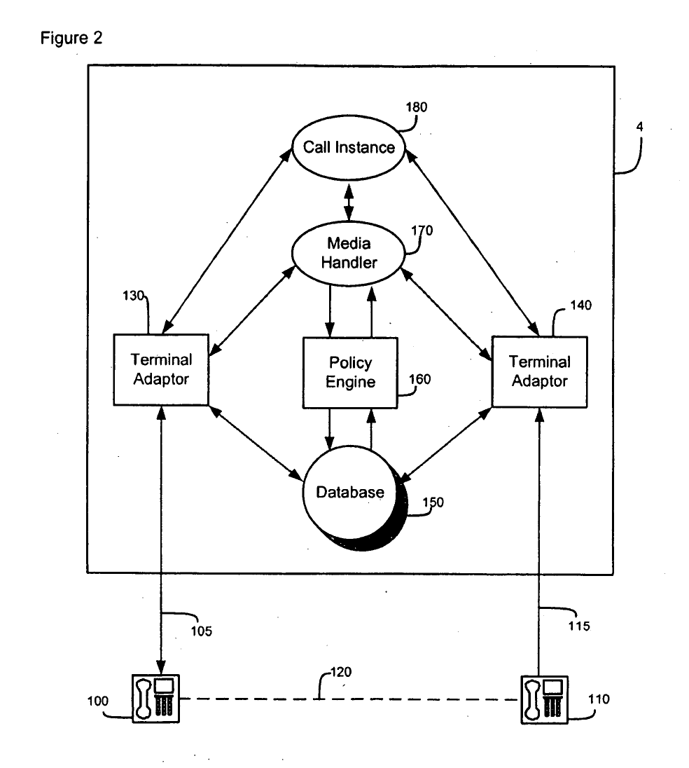

FIG. 2 is a block diagram illustrating software blocks for call server 4, according to an embodiment of an invention. This figure illustrates a scenario for a call between two telephones, for example, between phone 100 located at site 1 and phone 110 at located at site 5. However, it should be appreciated that this scenario is merely an example. In this example, phone 100 is the initiator of a call and phone 110 is the answerer. The media path 120 will carry the RTP packets of a media stream encoded by a negotiated codec for the call. Signaling is passed from phone 100 to call server 4 via signaling link 105 and between the call server 4 and the phone 110 via the signaling link 115. The call server includes an instance of a terminal adaptor for each phone. In this example terminal adaptor 130 is associated with phone 100 and terminal adaptor 140 is associated with phone 110. Call server 4 also includes a call instance module 180, a media handler 170, a policy engine 160, and a database 150. As can be seen communication paths exists between each of the elements. It should be appreciated that this is one example showing logical components and the interactions between.

Each instance of the Terminal Adaptor performs a number of functions:
1. Converts protocol used to interface to phone to internal view of call handling.
2. Determines the Codecs that the phone has available. This can be done dynamically via the signaling (e.g. from an SDP message from the phone), or via a priori knowledge of the phone stored in the database 150 (e.g., in the case of a stimulus phone).

Call Instance module 180 manages the call processing and is responsible for the signaling between the two terminals required to deliver the call. The Media Handler 170 uses the policy engine 160 to manage the flow of media descriptors between the terminals. The policy engine 160 implements the logic to determine which Codecs are preferred for the call. The policy engine 160 uses data in the database 150, as well as the information provided to the Media Handler 170 by the terminal adaptors (including the Codecs available, and the Site the phone has connected from) to determine the ordered preferences for the Codecs. Preferably the policy engine takes into account the site and codec info from both endpoints. If the policy engine can make a ruling as to which codec should be used for the call, it will enforce it, otherwise it will try to help the two endpoints decide. Accordingly, Depending on the embodiment, the policy engine 160 either determines the Codec for the call, or provides an ordered list of codes in order of preference based on policy decisions relating to the site and/or tenant.

We will now describe examples of Codec Negotiation, according to embodiments of the invention which use the offer/answer model based on SDP. However, the invention is not limited to SDP, and can be used with other protocols. Two participants are involved—one is known as the offerer and the other is referred to as the answerer.

Negotiation begins when the offerer sends an initial offer to the other participant (answerer). The initial offer typically comprises, a signaling message specifying the set of media streams, codecs, as well as the IP addresses and ports that the offerer would like to use to receive the media. The offer is conveyed to the answerer. The answerer generates an answer, which is a response message that responds to the offer. The answer contains a matching media stream for each stream in the offer, indicating whether the stream is accepted or not, along with the codecs that will be used and the IP addresses and ports that the answerer wants to use to receive media.

The signaling messages exchanged between the offerer and the answerer can be, for example, SDP messages as defined by RFC3264 Examples of the media attributes that maybe modified during the negotiation are: packetization interval, RFC 2833 payload type and codec.

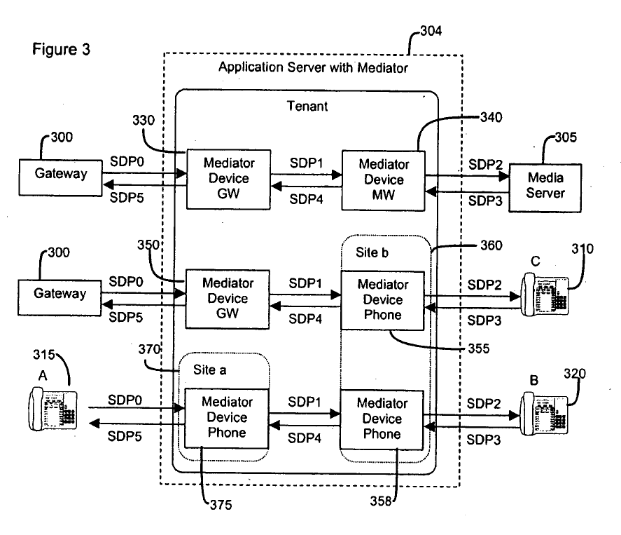

FIG. 3 is a block diagram illustrating SDP processing for three different scenarios according to an embodiment of the invention. FIG. 3 illustrates a distributed policy engine which is distributed between instances of terminal adaptors. Accordingly, each mediator device is a representation or an abstraction of the physical device. While not shown, such a model allows for multiple call servers (and therefore multiple negotiators) to interact, with the decision making of the policy engine being distributed between them. However, for the purpose of this figure a single call server for a single tenant is shown. FIG. 3 illustrates three exemplary calls and the signaling between elements to implement the calls. The first scenario illustrates an incoming external call, via gateway 300, which terminates with a media server 305 (for example a call attendant). The second scenario illustrates an incoming external call, in this example via the same gateway 300, although an alternative gateway could equally be used, terminating with an IP phone 310. The third scenario illustrates an intra-tenant, inter-site call between IP phone 315 and IP phone 320. An “external call” refers to a call to or from a “network device” (as opposed to a device located at a tenant site).

A Mediator Device is the Mediator's abstraction of the physical device. Three different examples of physical devices are present in the diagram: Gateway, Media Server and Phone.
The diagram has a number of SDPs shown. These are:
SDP0—The initial SDP
SDP1—The initial offer SDP processed by the originating Mediator Device
SDP2—The initial offer SDP processed by the terminating Mediator Device
SDP3—The answer SDP
SDP4—The answer SDP processed by the terminating Mediator Device
SDP5—The answer SDP processed by the originating Mediator Device.

In the first scenario the call server 304 establishes a mediator device abstraction 330 for gateway 300 as well as a mediator device abstraction 340 for the media server 305. As stated SDP1 and SDP4 are representations of signaling passed through the media handler between the mediator device 330 and mediator device 340. However, it should be appreciated the SDP1 and SDP4 need not necessarily be in the form of an SDP. If mediator device 330 and mediator 340 are located on different call servers (not shown) then actual SDPs may be passed. However, in the scenario shown, where both mediator device 330 and mediator device 340 are co-located within the same call server 304, then SDP1 and SDP4 are abstractions of information passing through the media handler between the two devices.

The following policy factors affect how the mediator processes the SDP in the exchanges:
What Codecs are preferred by the device
What Codecs are preferred at each site
Device scope
   The devices can be either Telco scope (e.g. shared network devices not at a site such as gateway, media server, conference server, voice mail) or tenant scope (e.g. terminals at a given tenant site). For example, in FIG. 3, Gateway 300 and Media Server 305 are Telco scope devices, whereas Phones 310, 315 and 320 are Tenant Scope. It should be noted that FIG. 3 illustrates the situation where phone 310 and 320 are both associated with site B 360 whereas phone 315 is associated with site A 370.
   The SDP from the offerer to the answerer is processed by the mediator to:

Strip codec in the SDP not supported by site/system

Re-order codec according to site/system preference

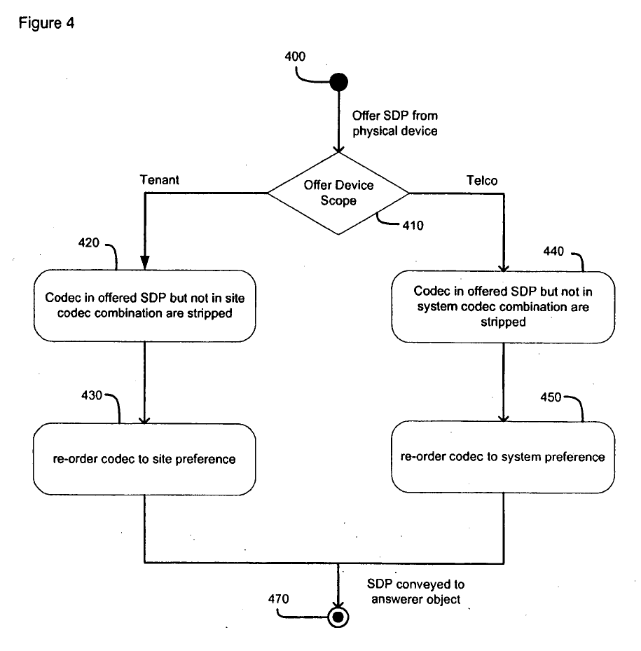

FIG. 4 is a flowchart illustrating the steps carried out by the Offerer endpoint abstraction device, for example, Mediator Device 375 of FIG. 3. The device receives 400 SDP0 400 from the physical device (for example phone 315). It then determines the Offerer Device Scope 410. If the device is a tenant device 420 then it strips the codecs which are offered in SDP0 but are not acceptable site codecs 420. Any remaining codecs are then re-ordered 430 according to site preference. Alternatively, if the offering device is a stimulus device, no SDP is received (as the stimulus device uses a stimulus protocol). However, the Mediator Device is aware of which Codecs are supported by the phone, and constructs SDP0 (As an alternative, it can simply construct SDP1 based on codecs supported by both the phone and device, and ordered accord to site preference). Meanwhile, if the offering device is a Telco device, then codecs in the offered SDP which are not in the system codec combination are stripped 440 and then the codec list is re-ordered according to system preference 450, or preferably re-ordered according to tenant preference if known. The re-ordered list SDP1 is then sent 470 to the answerer object, for example Mediator Device 358. As stated if the answer object is located at another call server than this may take the form of an SDP, although this is not necessary if both the Offerer Device and the answerer device are associated with the same call server, at which point appropriate internal signaling can be used

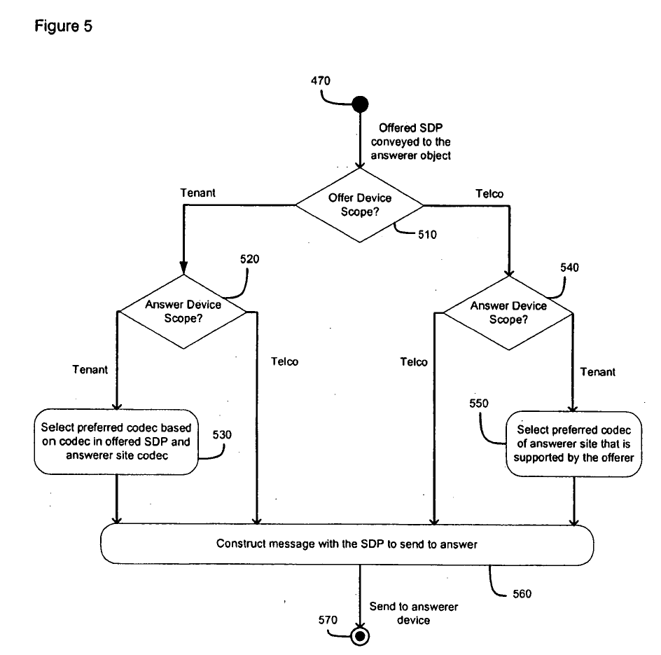

FIG. 5 is a flowchart similar to that of FIG. 4 but is carried out by the answerer endpoint abstraction device, for example, Mediator device 358 of FIG. 3 in constructing SDP2. In this example, the process begins with SDP1 from the offerer device 470. Once again the decision process depends on whether the offerer device scope 510. If the offerer device is a tenant device, the system determines the answering device scope 520. If the answer device is a tenant device then the system has enough information to effectively select which codec should be used (as both devices belong to the same tenant, and are therefore known. Accordingly, the list, if it contains more than one codec, is stripped and the single preferred codec based on the codec in the offerer SDP and the answerer site's preferred codec 530 is selected. However, if the answer device is a Telco device then the list in the offered SDP is not changed. Either way, SDP2 which includes the ordered list of codecs, is constructed 560 and sent to the physical answering device 570.

However if the offerer device scope (determined at 510) is a Telco device, the system determined the answerer device scope 540. If the answerer device is a Telco device then the SDP sent to the answerer 560 is same as that in 470. However, if the offerer device is a Telco device and the answerer device is a tenant device, then the preferred codec is selected based on the preference on the answerer site that is supported by the offerer 550. This single codec is then included in the SDP message 560 sent to the answerer device 570.

### Codec Negotiation Rules

The negotiation rules, according to an exemplary embodiment of the invention, are:
1. The initial SDP in the offer is the SDP provided by the device for those devices which have codec preference (ie sip terminal, mgcp terminal, sip gateway)
2. For devices which do not provide SDP in their signaling message, the mediator constructs the initial SDP on behalf of the device using the site codec preference list (and provisioned information as to which codecs are supported by the device); this is the SDP used in the initial offer.
3. Any codec in the initial offer that is not supported by the site is stripped from the SDP of the initial offer; codecs of the initial offer that are common to the codec list of the site are re-ordered to the site's preference list. Codecs supported by a site, tenant, or system, but not by the Offerer are not inserted.
4. If the most preferred codec is the same between two endpoints, select it.
5. For intra-tenant, inter-site calls if the two endpoints prefer different codecs, the lower bandwidth codec should be selected.
6. For calls between telco scope device (e.g. gateway, conference server, media server) and a tenant scope device (e.g. terminals), site preferred codec has a higher preference.
7. For calls between a telco scope device and another telco scope device, the system orders the codecs depending on whether the Tenant is known. If the tenant is known, then the codecs are ordered according to the tenant preference. If the tenant is not known, then the most preferred codec at the system level has a higher preference.
8. Call is denied and sent to treatment if a compatible codec cannot be negotiated.

### Operations, According to an Embodiment of the Invention

We now describe examples of how the above rules are executed, according to one specific implementation.

### Operation on the Initial SDP:

The device scope of the offerer and its codec preference affects the operation on the SDP of the initial offer:

| Device scope of | Offerer has codec | |
|---|---|---|
| Offerer | preference? | Mediator's operation on the Offer SDP |
| Tenant scope | Yes (e.g sip terminal) | strips off codecs in the offer SDP not |
| | | supported by the offerer's site; re-orders |
| | | the remaining codec to same codec |
| | | preference as the site |
| Tenant scope | No (e.g simple stimulus | creates the offer SDP using the |
| | terminal) | offerer's site codec list on behalf of the |
| | | offerer |
| Telco scope | Yes (e.g gateway) | strips off codecs in the offer SDP not |
| | | supported by the system; re-order the |
| | | remaining codec to same codec |
| | | preference as the system |

Operation on the SDP Before Conveying it to the Answerer

Before conveying the SDP to the answerer, the SDP is further modified by the mediator based on the characteristics of the answerer as follows:

| | | Answerer has | |
|---|---|---|---|
| Device scope | Device scope of | site codec | Mediator's operation on the SDP |
| of Offerer | Answerer | preference? | before conveying it to the Answer |
| Tenant scope | Tenant scope | Yes | If site codec combination of |
| | | | answerer is C1 and codec |
| | | | combination in the offered SDP is C2, |
| | | | calculate the intersection of C1 and |
| | | | C2. |
| | | | If the first codec of the site is same |
| | | | as the first codec of the intersection |
| | | | of C1 and C2, select it as the |
| | | | preferred codec. |
| | | | If the first codec of the site differs |
| | | | from the first codec of the intersection |
| | | | of C1 and C2, the preferred codec is |
| | | | a codec in both list which is preferred |
| | | | by either site and is the codec with a |
| | | | lower bandwidth. |
| | | | The SDP is updated with the |
| | | | preferred codec from and the codecs |
| | | | that are common to both C1 and the |
| | | | intersection of C1 and C2 before |
| | | | conveying it to the answerer |
| Tenant scope | Telco scope | No | No change to SDP |
| Telco scope | Tenant scope | Yes | If site codec combination of |
| | | | answerer is C1 and codec in the |
| | | | offered SDP is C2, calculate the |
| | | | intersection of C1 and C2. |
| | | | If the first codec of the site is same |
| | | | as the first codec of the intersection |
| | | | of C1 and C2, select it as the |
| | | | preferred codec. |
| | | | If the first codec of the site differs |
| | | | from the first codec of the intersection |
| | | | of C1 and C2, the preferred codec is |
| | | | a codec in both list which is preferred |
| | | | by the site. |
| | | | The SDP is updated with the |
| | | | preferred codec from and the codecs |
| | | | that are common to both C1 and the |
| | | | intersection of C1 and C2 before |
| | | | conveying it to the answerer |
| Telco scope | Telco scope | No | No change to sdp |

Similar operations are carried out in reverse for messages SDP3, SDP4 and SDP5 from the answer.

Device with no SDP Preference

### Offerer:

When initiating a call from a terminal without an SDP preference, the mediator constructs the initial SDP on behalf of the terminal with the following parameters:
   Provisioned site codec combination, and the associated RTPMap attribute for each codec.
   Provisioned packetization interval
   Provisioned 2833 DTMF payload type

### Answerer:

On the receiving end, when the mediator receives the offered SDP, the same logic outlined in previous section is applied to the offered SDP.
When answering the offer, the mediator constructs the answer SDP on behalf of the device, the answer SDP is constructed with the following parameters:
   The selected preferred codec, the RTPMap attribute associated with the preferred codec
   The packetization interval provided in the offered SDP
1) The 2833 DTMF payload type in the offered SDP.

### Additional Optional Features According to Embodiments of the Invention

When ever endpoints are changed, either as a result of action taken by the endpoint (transfer, or three way call), or by the Call Server, the mediator becomes involved in the signaling required by virtue of it's position. The mediator then re-negotiates the codec because an endpoint change might put the new endpoint in a different site, or at a different scope (e.g., from Site to Telco scope), with different topology considerations, and therefore different codec preferences.

The Call Server has a priori knowledge of the bandwidth available to each site. The Call Server also has knowledge of all RTP streams and the codecs used on the broadband connections to the site. As a result, the Call Server (which includes the mediator), according to an embodiment of the invention is able to restrict the number of calls attempted to/from the site to the amount of bandwidth available. This is important, because if too many calls are attempted across a finite capacity broadband link, at some point voice quality will degrade as their will not be sufficient bandwidth to support all the calls. Furthermore, as the access connection may be used for data transfers as well as voice, there may be a site policy decision to maintain a minimum amount of bandwidth for data (or types of data transfers, such as high priority email messages).

As but one example, if the access connection has only capacity for 10 voice calls (at least at a preferred codec), the mediator can stop the 11^{th} call. This can be done, for example, by stripping all of the codecs from the SDP, such that no compatible codec can be negotiated, sending the call to treatment as per rule 8. The purpose of such a treatment is to stop a blocked call in a graceful way (e.g. send the call to voicemail, provide a busy signal, etc)

However, blocking calls is typically undesirable. Accordingly, embodiments of the invention can take both pro-active and reactive steps to avoid such a situation.

According to an embodiment, if bandwidth is constrained, the mediator can change the codec combination policy from one that favors voice quality to one that favors bandwidth conservation (or vice-a-versa if there is ample bandwidth). In such an example, the mediator will set the codec combination for most calls such that codecs with lower bandwidth requirement are placed first in the codec combination. This optimizes the bandwidth such that devices which can accept a compressed codec will do so, conserving bandwidth for those that cannot be on the lower bandwidth. For example a foreign exchange station (fax) device will typically only be configured with a single codec (as compression will corrupt the analog data sent over the voice channel). Therefore, it will only have a single codec in its codec combination. Alternatively, the mediator can be programmed to not allow a fax call in such a situation, in order to conserve bandwidth. This is a business decision, based on business priorities. The mediator can prevent a codec from being used by stripping the codec from the ordered list if there is insufficient bandwidth. As stated, if no compatible codec is available, the call is denied and sent to treatment (which for example in the case of a fax call, can be the generation of a busy signal).

In addition, in some embodiments the Call Server is also able to take a reactive action when the number of calls across a broadband link is getting close to the maximum. For example, if bandwidth capacity on the access connection is approaching exhaustion, in order to ensure bandwidth is available for additional calls the Call Server can cause the re-negotiation of the Codecs in use to change the codec being used to one that uses a lower bandwidth.

The above-described embodiments of the present invention are intended to be examples only. Alterations, modifications and variations may be effected to the particular embodiments by those of skill in the art without departing from the scope of the invention, which is defined solely by the claims appended hereto.

1. A method of negotiating codecs between endpoints of a session comprising, at a mediator:
a. receiving from a first endpoint, a request for communication with a second endpoint, at least one of said endpoints being a mediator associated endpoint which communicates via an access connection;
b. evaluating said request and retrieving codec policy criteria dependent on said access connection; and
c. determining, based at least in part on said codec policy criteria, an ordered list of codecs to include in codec negotiation messages for said mediator associated endpoint.

2. A method as claimed in claim 1 wherein said mediator receives signaling messages from said mediator associated endpoint and further comprising:
sending codec negotiation messages which include said ordered list of codecs for said mediator associated endpoint.

3. A method as claimed in claim 2 wherein said codec policy criteria depends on topology information.

4. A method as claimed in claim 3 wherein said topology information comprises bandwidth constraints of said access connection.

5. A method as claimed in claim 4 wherein said mediator associated endpoint belongs to a site, wherein devices at said site share said access connection, and wherein said policy provides site preferred codec combinations.

6. A method as claimed in claim 4 wherein said policy additionally provides tenant preferred codec combinations.

7. A method as claimed in claim 2 wherein said method further comprises determining a bandwidth constraint associated with said mediator associated endpoint and wherein said criteria includes said bandwidth constraint.

8. A method as claimed in claim 7 wherein said step of determining bandwidth constraint comprises retrieving said bandwidth constraint from a database of provisioned topology information.

9. A method as claimed in claim 7 wherein said step of determining bandwidth constraint comprises measuring the available bandwidth capacity of said access connection.

10. A method as claimed in claim 2, wherein said received request for communication comprises an SDP offer message including Codec information from said first endpoint, and said sending step comprises replacing said Codec information from said first endpoint with said ordered list of codecs.

11. A method as claimed claim 10 wherein said replacing step comprises altering said request to include said ordered list of codecs.

12. A method as claimed claim 10 wherein said replacing step comprises formulating a new request including said ordered list of codecs and sending said new request to said second endpoint.

13. A method as claimed in claim 1 wherein said determining step orders the ordered list of codecs based in part on their affect to other services sharing said access connection.

14. A method as claimed in claim 1 further comprising said mediator monitoring the bandwidth capacity of said access connection and instructing said endpoints to change codecs based on changes in said bandwidth capacity.

15. A method as claimed in claim 14 wherein said mediator considers a request for a new call a change in bandwidth capacity.

16. A method as claimed in claim 1 wherein said determining step comprises:
determining possible codecs;
determining bandwidth requirements of each of said possible codecs; and
ranking said possible codecs based on said bandwidth requirements and said policy.

17. A method as claimed in claim 1 further comprising carrying out said steps for an answer from said second endpoint.

18. A method as claimed in claim 1 wherein said mediator can identify if an endpoint is at a bandwidth-constrained site or in the core of the network.

19. A method as claimed in claim 18 wherein the mediator can give higher importance to the codec preferences of a bandwidth-constrained site than to the preference of a core endpoint to influence the negotiation.

20. A method as claimed in claim 1 wherein one of said endpoints uses Session Description protocol messages, and the other endpoint does not, and wherein said mediator creates and responds to SDP messages on behalf of said other endpoint.

21. A method as claimed in claim 1 wherein said policy implements a set of negotiation rules comprising:
a. If there are no common codecs, then the call should be denied;
b. If there is one common codec, use it;
c. If there is more than one common codec, then look at the preferred codec for all sites involved in said call:
i. If the preferred codecs are the same, then use it.
ii. If the preferred codecs are different, then use the lower bandwidth codec.

22. For a system which negotiates codecs via signaling messages between endpoints, wherein each endpoint advertises the preferred order of allowed codecs within said signaling messages, a mediator for a device associated with said mediator, said mediator comprising a processor and computer readable medium tangibly embodying software instructions, which when executed by said processor, causes said mediator to:
a. intercept signaling messages relating to said device;
b. re-order said preferred order of allowed codecs according to policy;
c. transmit signaling messages which contain said re-ordered preferred order of allowed codecs.

23. A mediator as claimed in claim 22 wherein said policy comprises a hierarchy of policies, each level of which specifies a trade-off between bandwidth and quality.

24. A mediator as claimed in claim 23 wherein said hierarchy depends on administrative domains at one level, and topology at another level.

25. A mediator as claimed in claim 22 wherein said re-order said preferred order of allowed codes comprises stripping non allowed codecs from messages which contain them, and then re-ordering based on said policy.

26. A mediator as claimed in claim 22, wherein said policy provides a preferred order of allowed codecs for a site associated with said endpoint.

27. A mediator as claimed in claim 22 wherein said messages relating to said device include messages to and from said device.

28. A mediator as claimed in claim 22, wherein said mediator forms part of a multi-tenant VoIP system, and wherein each tenant can have its own policy, wherein each tenant represents an administrative domain for an organization which includes one or more sites.

29. A feature server comprising the mediator of claim 22.

30. A computer program product tangibly embodied in a computer readable medium, which when executed by a processor of a feature server, causes said feature server to act as mediator as claimed in any of the proceeding claims.

31. A feature server comprising:
a. means for receiving from a first endpoint, a request for communication with a second endpoint, at least one of said endpoints being associated with said feature server;
b. means for evaluating said request and retrieving codec policy criteria dependent on topology information;
c. means for determining, based at least in part on said codec policy criteria, an ordered list of codecs to include in codec negotiation messages for said endpoints; and
d. means for sending said codec negotiation messages to said endpoints.
